(19) United States
(12) Patent Application Publication
(10) Pub. No.: US 2008/0248170 A1
(43) Pub. Date: Oct. 9, 2008

(54) Re-usable toy candy stick with a holding ring and a cross guard plate

(76) Inventor: Sung So Lee, Los Angeles, CA (US)

Correspondence Address: Eugene Oak, 610 S. Van Ness Ave., Los Angeles, CA, 90005, US

(21) Appl. No.: 11/784,585

(22) Filed: Apr. 9, 2007

(51) Int. Cl. A23G 3/50

(52) U.S. Cl. 426/110

(57) ABSTRACT

A toy candy stick is provided. The candy stick according to current application is comprised of a holding ring and a cross-guard plate. A stick candy is engaged to the center of a face of the cross-guard plate. Various kind of engaging grooves are formed at the center of the face thereon, on the opposite side of the holding ring. The cross-guard plate prevents the candy from sucked into user's mouth and chuck the user's neck by accident. The holding ring provides a more solid grip of the candy.

### FIELD OF THE INVENTION

Current application relates to a candy stick, especially to a candy stick equipped with a holding ring and a cross-guard plate to enhance safety of a candy stick.

### BACKGROUND OF THE INVENTION

There are many kind of stick candies are on the market. Most popular type is a ball shape candy with a straight stick or a tube made of a soft plastic or paper rod. However, those candies on a straight stick are exposed to a danger of sucked into mouth of the user and choke the throat. It is especially danger when the user is an infant of age under two. Since almost all of infants do not have ability to hold the stick firmly enough, the candy is easily introduced into the infant's mouth and choke the throat. Even for children over age two, it is also dangerous when a child is fall with the candy on a straight stick in the her/his mouth. If the candy is almost melt out by the child's spittle and tip of the straight stick is exposed, the exposed tip of the stick would heart inside of mouth of the child as she/he fall. In addition to this, most of stick used for holding candy is disposable. When the stick is disposed, sticky candy remains on the stick. The disposed stick not only contaminates environment but also stick to cloth of the child or other people. It is the purpose of current application to provide a candy stick that is more safe for infants/children while minimize contamination of environment by disposed candy stick of prior art.

### DESCRIPTION OF THE PRIOR ART

U.S. Patent Application 20060286283 to Yoon; Jeong Min illustrates a luminous candy comprises: a body portion; a stick portion a portion of which is inserted into the body portion; and a luminous portion provided in the stick portion so that the light is emitted when the stick portion is bent. U.S. Patent Application 2006 0155331 to Bohmer; Bernard Roald illustrates a pacifier for receiving a cartridge containing flavor substances for oral intake. U.S. Patent Application 2005 0239367 to Fernandez, Rodolfo JR. illustrates a combined portable fan-candy holder toy, which comprises any kind of portable fan built in a great variety of shapes. U.S. Patent Application 20050095325 to Rycroft, Kendall illustrates a flexible wrist bracelet that has a pivotal receiver for a stick of a lollipop and a cover for the entire lollipop that lies against the arm of the user or wearer. U.S. Patent Application 20040156955 to Klima, William L. illustrates a candy sucker article. Specifically, the candy sucker article includes a manually rotatable candy sucker in combination with a container. U.S. Patent Application 2003 0152672 to Coleman, Thomas J.; et al.illustrates a candy sucker in combination with a container having multiple compartments and/or multiple suckers. U.S. Patent Application 20030059504 to Coleman, Thomas J.; et al. illustrates a candy holder that combines two separate types of candy which can be combined by a user in order to provide different tastes.

U.S. Pat. No. 7,014,877 to Lobl illustrates a lollipops with a stick made of a flexible material in combination with a compact lollipop container. U.S. Pat. No. 6,242,021 to Rooney, et al. illustrates a small, bite-sized snack food item is disclosed which combines a pretzel stick and a group of cereal rings annularly disposed on the stick, thereby combining the flavor of the pretzel with the flavor of the cereal in a bite-sized unit. U.S. Pat. No. 6,135,606 to Fernandez, et al. illustrates a hand held toy to hold translucent Lollypops or other similar sucker candies producing illumination from the interior of the candy in such a way that tiny light spots blink varying in color and position, to increase children amuse while using the holder with the candy. U.S. Pat. No. 6,177,110 Chan illustrates a lollipop comprises a ball of hard candy and an edible stick having a first end extending into a cavity in the ball. U.S. Pat. No. 4,192,307 to Baer illustrates a pacifier for infants, having a nipple provided with a chamber, the wall of which has perforations. U.S. Pat. No. 4,141,578 to Zinder illustrates an integral straight rigid holder stick that is provided for use in making confectionary products, especially candy apples.

None of the prior arts illustrates a safe and environmentally affirmative candy stick as shown in the current application.

### SUMMARY OF THE INVENTION

There are many kind of stick candies are on the market. Most popular type is a ball shape candy with a straight stick or a tube made of a soft plastic or paper rod. However, those candies on a straight stick are exposed to a danger of sucked into mouth of the user and choke the throat. It is especially danger when the user is an infant of age under two. Since almost all of infants do not have ability to hold the stick firmly enough, the candy is easily introduced into the infant's mouth and choke the throat. Even for children over age two, it is also dangerous when a child is fall with the candy on a straight stick in the her/his mouth. If the candy is almost melt out by the child's spittle and tip of the straight stick is exposed, the exposed tip of the stick would heart inside of mouth of the child as she/he fall. In addition to this, most of stick used for holding candy is disposable. When the stick is disposed, sticky candy remains on the stick. The disposed stick not only contaminates environment but also stick to cloth of the child or other people. It is the purpose of current application to provide a candy stick that is more safe for infants/children while minimize contamination of environment by disposed candy stick of prior art. The candy stick according to current application is comprised of a holding ring and a cross-guard plate. A stick candy is engaged to the center of a face of the cross-guard plate. Various kind of engaging grooves are formed at the center of the face thereon, on the opposite side of the holding ring. The cross-guard plate prevents the candy from sucked into user's mouth and chuck the user's neck by accident. The holding ring provides a more solid grip of the candy. The candy stick according to current application not only reduces danger to infants and children but also minimize contamination by disposed sticky candy stick.

### BRIEF DESCRIPTION OF DRAWINGS

FIG. 1 is a side view of a re-usable toy candy stick with a holding ring and a cross-guard plate according to current application.

FIG. 2 is a front view of a first embodiment of a re-usable toy candy stick with a holding ring and a cross-guard plate according to current application.

FIG. 3 is a cross-sectional view of the first embodiment of the re-usable toy candy stick with a holding ring and a cross-guard plate according to current application along the line A-A′ in FIG. 2.

FIG. 4 is a perspective view of the first embodiment of the re-usable toy candy stick with a holding ring and cross-guard plate receiving a candy with a screw ended stick.

FIG. 5 is a front view of a second embodiment of a re-usable toy candy stick with a holding ring and a cross-guard plate according to current application.

FIG. 6 is a cross-sectional view of the second embodiment of the re-usable toy candy stick with a holding ring and a cross-guard plate according to current application along the line B-B′ in FIG. 4.

FIG. 7 is a perspective view of the second embodiment of the re-usable toy candy stick with a holding ring and cross-guard plate receiving a candy with an elbow ended stick.

FIG. 8 is a rear view of both of the first and second re-usable toy candy stick with a holding ring and cross-guard plate.

### DETAILED DESCRIPTION OF THE PREFERRED EMBODIMENT

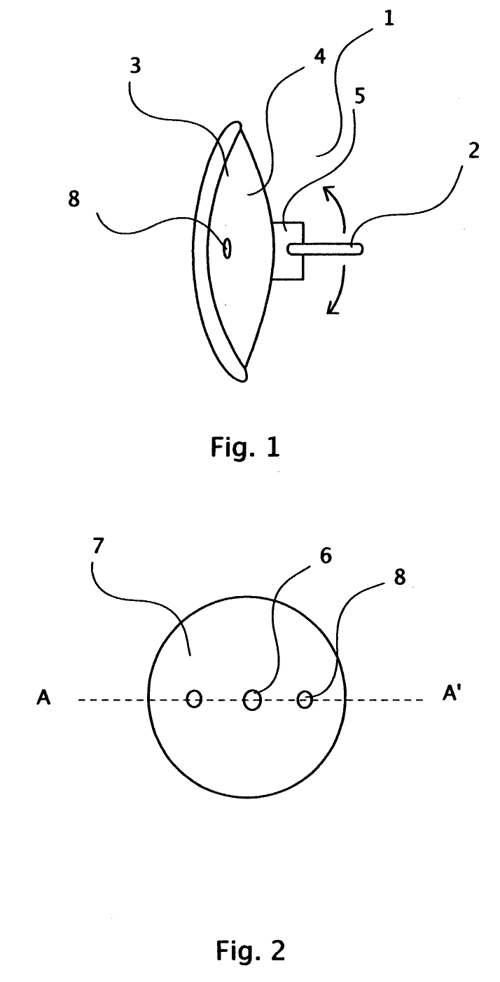

FIG. 1 is a side view of a re-usable toy candy stick (1) with a holding ring (2) and a cross-guard plate (3) according to current application. The holding ring (2) is rotate-ably connected to the rear face (4) of the cross-guard plate (3) via a ring connector (5). Shape of the ring (2) may be varied such as star, heart, square, etc. Shape of the cross-guard plate (3) may be varied such as face of tiger, lion, rabbit etc., or other natures such as star, sun, etc. The cross-guard plate (3) is made of one of flexible plastic such as silicon, Tygon®, Nylon®, and flexible PVC (Poly Vinyl Chloride) or mixture thereof. The cross-guard plate (3) may be formed as trans-parent or opaque depend on customer needs.

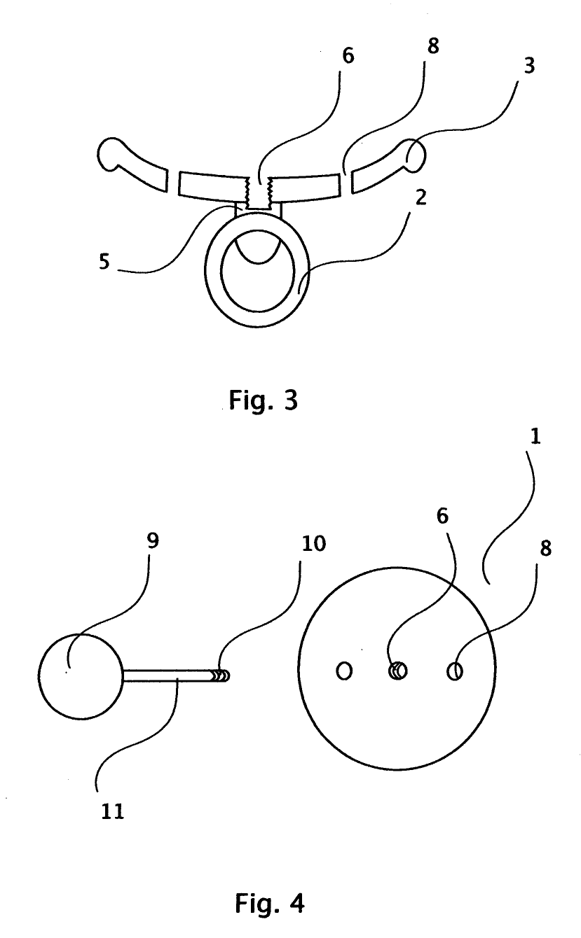

FIG. 2 is a front view of a first embodiment of the re-usable toy candy stick (1) with a holding ring (2) and a cross-guard plate (3) according to current application. And FIG. 3 is a cross-sectional view of the first embodiment of the re-usable toy candy stick (1) with a holding ring (2) and a cross-guard plate (3) according to current application along the line A-A′ in FIG. 2. An engaging groove of female screw (6) is developed on the center of the front face (7) of the cross-guard plate (3). Since the cross-guard plate (3) is made of flexible plastic, the plate (3) may stick to mouth to user's mouth. To prevent the cross-guard plate (3) from sticking to the user's mouth, two air holes (8) are developed on the cross-guard plate (3) penetrating there through.

FIG. 4 is a perspective view of the first embodiment of the re-usable toy candy stick (1) with a holding ring (2) and cross-guard plate (3) receiving a candy (9) with a stick (11) of male-screwed end (10). The male-screwed end (10) of the candy (9)'s stick (11) is engaged to groove of the female screw (6) to fasten the candy (9) to the toy candy stick (1) according to current application.

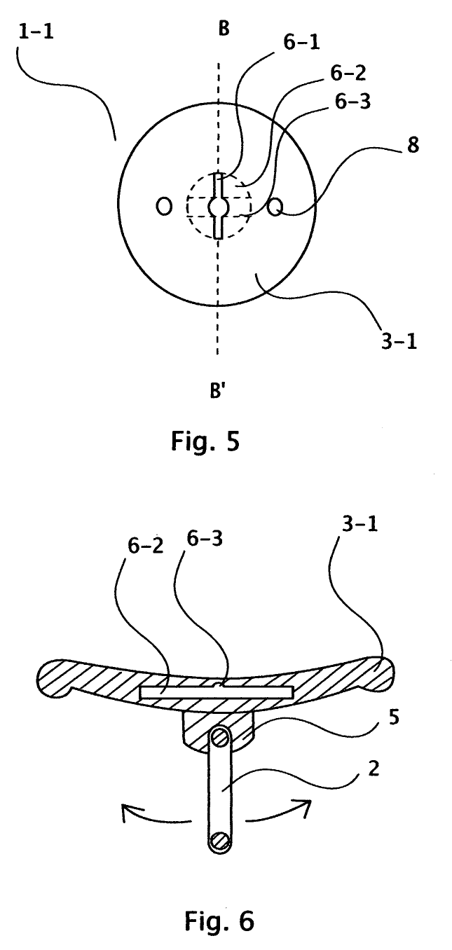

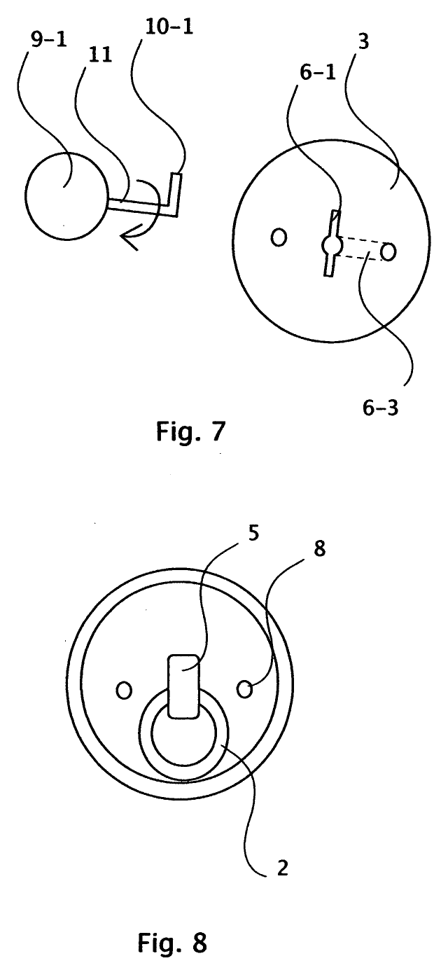

FIG. 5 is a front view of a second embodiment of a re-usable toy candy stick (1-1) with a holding ring (2) and a cross-guard plate (3-1) according to current application. FIG. 6 is a cross-sectional view of the second embodiment of the re-usable toy candy stick (1-1) with a holding ring and a cross-guard plate according to current application along the line B-B′ in FIG. 4. A slit (6-1) with an internal space (6-2) and internal lock (6-3) is developed inside of the cross-guard plate (3-1). FIG. 7 is a perspective view of the second embodiment of the re-usable toy candy stick (1-1) with a holding ring (2) and cross-guard plate (3-1) receiving a candy (9-1) with an elbow ended (10-1) stick (11). The candy (9-1) with an elbow ended (10-1) stick (11) is engaged to the internal lock (6-3) by inserting the elbow ended (10-1) stick (11) into the slit (6-1) and turning 90 degrees. Then the elbow end (10-1) moves along the internal space (6-2) and engaged to the internal lock (6-3). Due to the flexibility of the cross-guard plate (3-1), the elbow end (10-1) is pressed and engaged firmly to the internal lock (6-3).

FIG. 8 is a rear view of both of the first and second re-usable toy candy stick (1) with a holding ring (2) and cross-guard plate (3). Irrespective of the embodiments, rear views of the re-usable toy candy stick (1) with a holding ring (2) and cross-guard plate (3) is the same.

What is claimed is;

1. A re-usable toy candy stick is comprised of:
a cross guard plate that is made of flexible, transparent plastic,
and has an engaging groove of a female screw, which is developed on the center of the front face thereof and penetrates the cross-guard plate and reach to half depth of a ring connector, to engage a candy stick with a male-screw end,
and has two air holes that penetrate the cross-guard plate to prevent the cross-guard plate from sticking to user's mouth, and
a holding ring that is rotate-ably connected to rear face of the cross-guard via a ring connector and has a shape of circular ring.

2. A re-usable toy candy stick is comprised of:
a cross guard plate that is made of flexible, transparent plastic, and has a slit with an internal space and internal lock, which is developed on the center of the front face thereof to engage a candy stick with an elbow end, and has two air holes that penetrate the cross-guard plate to prevent the cross-guard plate from sticking to user's mouth, and
a holding ring that is rotate-ably connected to rear face of the cross-guard via a ring connector and has a shape of circular ring.

3. A re-usable toy candy stick of claim 1, wherein the cross-guard plate is concavely bent to match to a user's mouth surface.
